(19) United States
(12) Patent Application Publication
(10) Pub. No.: US 2002/0085652 A1
(43) Pub. Date: Jul. 4, 2002

(54) Automatic frequency control unit and spectrum spread receiving apparatus

(76) Inventors: Seiji Okubo, Tokyo (JP); Toshiharu Kojima, Tokyo (JP)

Correspondence Address: BIRCH STEWART KOLASCH & BIRCH, PO BOX 747, FALLS CHURCH, VA, 22040-0747, US

(21) Appl. No.: 09/985,894

(22) Filed: Nov. 6, 2001

(30) Foreign Application Priority Data
Nov. 7, 2000 (JP) 2000-339693

(51) Int. Cl. H04L 27/06

(52) U.S. Cl. 375/344; 375/130

(57) ABSTRACT

In the automatic frequency control apparatus, a correlation between a complex spectrum spread signal and a spread code is computed to output a complex correlation signal. A sample clock for sampling the complex spectrum spread signal and a data clock synchronous with a repetitive period of the spread code are generated based on the complex correlation signal. Delay correcting sections correct the delays so that generation timings of the correlation peak values with respect to each parallel transmission signal of each of the complex correlation signals divided to N signals. Latch sections latch the correlation peak value using a data clock and a synthetic frequency error signal generating section for generating a synthetic frequency error signal based on each signal. Frequency offset of the local carrier is corrected based on the synthetic frequency error signal.

### FIELD OF THE INVENTION

The present invention relates to a spectrum spread apparatus for carrying out spectrum spread modulation upon parallel information signals according to direct spread (DS) method. Particularly, this invention relates to an automatic frequency control apparatus which carries out frequency synchronization of local carrier in transmission signal generated by multiplying each spectrum spread modulation signal multiplexed after a different delay time is given, with the carrier, and a spectrum spread receiving apparatus that uses such an automatic frequency control apparatus.

### BACKGROUND OF THE INVENTION

In mobile communication system, the spectrum spread (SS) method has been attracting much attention as a transmission system for image, voice and other data. This spectrum spread communication method includes direct spread method, frequency hopping (FT) method and the like. In the DS method, communication is carried out by multiplying a spread code having a far wider band than information signal directly with the information signal (by spectrum-spread information signal).

If the direct spread type spectrum spreading (DS/SS) communication is applied to the mobile communication system, it is desirable for the receiving apparatus to carry out quasi-synchronous detection because reproduction of the carrier is difficult. However, if frequency offset exists in the local carrier when the quasi-synchronous detection is carried out, bit error ratio characteristic deteriorates. For this reason, the receiving apparatus needs to include an automatic frequency control (AFC) apparatus, which compensates for the frequency offset in the local carrier.

FIG. 9 is a diagram showing the structure of the conventional DS/SS receiving apparatus. In this figure, reference numeral 11 denotes a complex correlation computing section, reference numeral 19 denotes a multiplier, reference numeral 20 denotes an integrator, reference numeral 21 denotes a D/A converting section, reference numeral 22 denotes a voltage control oscillator (VCO), reference numeral 23 denotes a phase shift section, reference numerals 24, 25 denote multipliers, reference numerals 26, 27 denote low-pass filters (LPF), reference numerals 28, 29 denote A/D converting sections, reference numeral 100 denotes a code synchronizing section, reference numeral 101 denotes a latch section, reference numeral 102 denotes a data demodulating section, reference numeral 103 denotes a delay section, reference numeral 104 denotes a complex conjugation computing section, reference numeral 105 denotes a multiplier, reference numeral 106 denotes a real number part separating section, reference numeral 107 denotes an imaginary number part separating section and reference numeral 108 denotes a multiplier.

This conventional DS/SS receiving apparatus operates as follows. The multiplier 24 multiplies local carrier output from the VCO 22 with received SS signal, the low-pass filter 26 removes harmonic components of a signal after the multiplication and further, the A/D converting section 28 samples with a sample clock having a frequency band M (where M is a natural number) times a chip rate R_{c}. Consequently, the same phase component as the complex spectrum spread signal having a digital value and further a frequency band M times the chip rate R_{c} is generated.

The multiplier 25 multiplies a local carrier shifted in phase by π/2 with the received SS signal at the phase shift section 23 so as to generate an orthogonal component of the complex spectrum spread signal having a digital value and a frequency band M times R_{c} in the same procedure as described above. Quasi-synchronous detection is carried out using the VCO 22, the phase shift section 23, the multipliers 24, 25 and the LPFs 26, 27.

The complex correlation computing section 11 computes the correlation between each complex spectrum spread signal and the spread code used in spectrum spread of the received SS signal so as to output a result of this computation as a complex correlation signal.

The code synchronizing section 100 generates a data clock synchronous with a spread code period contained in the received SS signal and a sample clock having a frequency band M times a chip rate R_{c} by using the aforementioned complex correlation signal.

On the other hand, the latch section 101 latches a peak value of a complex correlation signal output from the complex correlation computing section 11 with data clock. The data demodulating section 102 carries out demodulation processing corresponding to primary modulation method based on the peak value of the latched complex correlation signal so as to output demodulation data.

The delay section 103, the complex conjugation computing section 104, the multiplier 105, the real number part separating section 106, the imaginary number part separating section 107, the multiplier 108, the multiplier 109, the integrator 20, the D/A converting section 21 and the VCO 22 carry out frequency synchronization of local carrier using a complex correlation signal latched by the latch 101. The frequency synchronization of the local carrier is performed as follows. It is assumed that primary modulation is BPSK, the length of the spread code for use in spectrum spread, chip period is T_{c}, and the value of the spread code of m (m=1, . . . , L) is uₘ∈{−1, 1} (where L is a natural number). Further, it is assumed that data symbol period is Tₚ=LT_{c}, the value of transmission data at time nTₚ (n is an integer) is aₙ∈{−1, 1} and the angular frequency of transmission carrier is ω_{c}.

The DS/SS receiving apparatus receives, for example, a received SS signal aₙuₘcos [ω_{c} (nTₚ+mT_{c})] at time nTₚ+mT_{c}. If it is assumed that the angular frequency of the local carrier for use in quasi-synchronous detection is ω_{c}+Δω, its initial phase is φ and the sampling period of the A/D converting section is equal to the chip period, so that there is no quantization error, a complex spectrum spread signal r_{nL+m} at time nTₚ+mT_{c}=(nL+m)T_{c} can be obtained from the following equation (1).

r_{nL+}m=aₙuₘexp[−j{Δω(nL−m)T_{c}+φ}] (1)

This complex spectrum spread signal is input to the complex correlation computing section 11 and correlation between this and a spread signal multiplied with the received SS signal is computed so as to generate a complex correlation signal. If a complex correlation signal corresponding to transmission data aₙ when code is synchronous is assumed to be cₙ, the cₙ can be obtained from the following equation (2).

$$\begin{matrix}{C}_{n} = \frac{1}{L} {\sum }_{m = 1}^{L} {u}_{m} {r}_{nL + m} \\ = {a}_{n} \frac{sin [ \frac{Δ ω L {T}_{c}}{2} ]}{sin [ \frac{Δ ω {T}_{c}}{2} ]} exp [ - jΔω \{ ( 2 n + 1 ) L + 1 \} {T}_{c} + \frac{2 φ}{2} ]\end{matrix} \qquad ( 2 )$$

The multiplier 105 computes a result (“multiplication value”) Zₙ of multiplication of a value Cₙ Of the complex correlation signal and a complex conjugation cₙ₋₁ of a complex correlation signal a symbol before. This multiplication value Zₙ can be obtained from the following equation (3)

$$\begin{matrix}{Z}_{n} = {C}_{n} {C}_{n - {1}^{*}} \\ = {a}_{n} {a}_{n - 1} \frac{{[ \frac{sin ( Δ ω L {T}_{c} )}{2} ]}^{2}}{{[ \frac{sin ( Δ ω {T}_{c} )}{2} ]}^{2}} exp [ - j Δ ωL {T}_{c} ]\end{matrix} \qquad ( 3 )$$

The multiplier 108 multiplies a real number part of Zₙ output from the real number part separating section 106 10 with an imaginary number part of Zₙ output from the imaginary number part separating section 107 so as to output a frequency error signal eₙ deprived of modulation component aₙ and modulation component aₙ₋₁. The frequency error signal eₙ can be obtained from the following equation (4).

$$\begin{matrix}{e}_{n} = Re [ Zn ] \times Im [ Zn ] \\ = \frac{{[ \frac{sin ( Δ ω L {T}_{c} )}{2} ]}^{4}}{{[ \frac{sin ( Δ ω {T}_{c} )}{2} ]}^{4}} \times \frac{sin ( - 2 Δω L {T}_{c} )}{2}\end{matrix} \qquad ( 4 )$$

FIG. 10 is a diagram showing a frequency error signal eₙ normalized by L⁴ with respect to the frequency offset Δω. In FIG. 10, the length of the spread code is set to 63. In this way, a frequency error signal eₙ corresponding to the value of the frequency offset Δω is obtained by the signal processing and further, the multiplier 19 and the integrator 20 raise the S/N ratio of the frequency error signal. After that, the D/A converting section 21 carries out D/A conversion upon that frequency error signal. Consequently, the VCO 22 removes the frequency offset by using a frequency control signal generated by D/A conversion, thereby achieving the frequency synchronization of the local carrier.

However, when carrying out the code multiplexing to execute the parallel information transmission in the conventional spectrum spread receiving apparatus, complex correlators of the same quantity as multiplexings to be carried out for synchronizing the frequencies of the local carriers are needed in order to execute the parallel information transmission (conventionally, the frequency synchronization is carried out using a peak value of a complex correlation signal of a single channel). Therefore, the conventional case has such a problem that its circuit scale expands.

As a method for preventing the expansion of the circuit scale of the demodulator, it is possible to consider a method in which an additional dedicated channel for the frequency synchronization is provided to carry out the frequency synchronization of the local carrier using reverse spread information of this dedicated channel. However, as compared to a case in which the frequency synchronization is carried out using the reverse spread information about all channels, estimation accuracy of the frequency error signal deteriorates, so that accompanied thereby, data demodulation characteristic also deteriorates.

### SUMMARY OF THE INVENTION

It is an object of this invention to provide an automatic frequency control apparatus capable of executing frequency synchronization of local carrier at a high precision without expanding its circuit scale in case of carrying out code multiplexing so as to execute parallel information transmission and a spectrum spread receiving apparatus employing the same automatic frequency control apparatus.

The automatic frequency control apparatus according to one aspect of this invention comprises: a quasi-synchronous detecting unit which generates a complex spectrum spread signal by mixing an orthogonal local carrier in received SS signal; a complex correlation computing unit which computes the correlation between the complex spectrum spread signal and a spread code so as to output a complex correlation signal as its computation result; a code synchronizing unit which generates a sample clock for sampling the complex spectrum spread signal and a data clock synchronous with a repetitive period of the spread code based on the complex correlation signal; a delay correcting unit which divides the complex correlation signal to N (N is the quantity of binary parallel information system on the transmission side) and correcting the delays thereof so that peak value occurrence timings of complex correlation signals with respect to each binary parallel information are matched; a latch unit for latching a peak value of the complex correlation signal with respect to each binary parallel information using the data clock so as to output a complex correlation peak signal; a synthetic frequency error signal generating unit for generating a synthetic frequency error signal based on the each complex correlation peak signal; and a frequency correcting unit for correcting frequency offset of the local carrier based on each synthetic frequency error signal.

The automatic frequency control apparatus according to another aspect of this invention comprises: a quasi-synchronous detecting unit which generates a complex spectrum spread signal by mixing an orthogonal local carrier in received SS signal; a complex correlation computing unit which computes the correlation between the complex spectrum spread signal and a spread code so as to output a complex correlation signal as its computation result; a code synchronizing unit which generates a sample clock for sampling the complex spectrum spread signal and a data clock synchronous with a repetitive period of the spread code based on the complex correlation signal; a delay correcting unit which divides the complex correlation signal to N (N is the quantity of binary parallel information system on the transmission side) and correcting the delays thereof so that peak value occurrence timings of complex correlation signals with respect to each binary parallel information are matched; a latch unit which latches a peak value of the complex correlation signal with respect to each binary parallel information using the data clock so as to output a complex correlation peak signal; an automatic frequency control apparatus which computes an estimated frequency offset amount based on the each complex correlation peak signal so as to shift the each complex correlation peak signal by only a phase shift amount corresponding to the estimated frequency offset amount.

The spectrum spread receiving apparatus according to still another aspect of this invention comprises: a quasi-synchronous detecting unit which generates a complex spectrum spread signal by mixing an orthogonal local carrier in received SS signal; a complex correlation computing unit which computes the correlation between the complex spectrum spread signal and a spread code so as to output a complex correlation signal as its computation result; a code synchronizing unit which generates a sample clock for sampling the complex spectrum spread signal and a data clock synchronous with a repetitive period of the spread code based on the complex correlation signal; a delay correcting unit which divides the complex correlation signal to N (N is the quantity of binary parallel information system on the transmission side) and correcting the delays thereof so that peak value occurrence timings of complex correlation signals with respect to each binary parallel information are matched; a latch unit which latches a peak value of the complex correlation signal with respect to each binary parallel information using the data clock so as to output a complex correlation peak signal; a synthetic frequency error signal generating unit which generates a synthetic frequency error signal based on the each complex correlation peak signal; a frequency correcting unit which corrects frequency offset of the local carrier based on the synthetic frequency error signal; and a data demodulating unit which carries out data demodulation processing upon the each complex correlation peak signal so as to generate demodulation data corresponding to binary parallel information series on transmission side.

The spectrum spread receiving apparatus according to still another aspect of this invention comprises: a quasi-synchronous detecting unit which generates a complex spectrum spread signal by mixing an orthogonal local carrier in received SS signal; a complex correlation computing unit which computes the correlation between the complex spectrum spread signal and a spread code so as to output a complex correlation signal as its computation result; a code synchronizing unit which generates a sample clock for sampling the complex spectrum spread signal and a data clock synchronous with a repetitive period of the spread code based on the complex correlation signal; a delay correcting unit which divides the complex correlation signal to N (N is the quantity of binary parallel information system on the transmission side) and correcting the delays thereof so that peak value occurrence timings of complex correlation signals with respect to each binary parallel information are matched; a latch unit which latches a peak value of the complex correlation signal with respect to each binary parallel information using the data clock so as to output a complex correlation peak signal; an automatic frequency control apparatus which computes an estimated frequency offset amount based on the each complex correlation peak signal so as to shift the each complex correlation peak signal by only a phase shift amount corresponding to the estimated frequency offset amount; and a data demodulating unit which carries out data demodulation processing upon each complex correlation peak signal after the phase shift so as to generate demodulation data corresponding to binary parallel information series on transmission side.

Other objects and features of this invention will become apparent from the following description with reference to the accompanying drawings.

### BRIEF DESCRIPTION OF THE DRAWINGS

FIG. 1 is a diagram showing the structure of a first embodiment of the spectrum spread receiving apparatus according to the present invention;

FIG. 2 is a diagram showing the structure of a transmission side;

FIG. 3 is a diagram showing the structure of a modulation component removing section;

FIG. 4 is a diagram showing the structure of a code synchronizing section;

FIG. 5 is a diagram showing the structure of a synthetic frequency error signal generating section according to a second embodiment;

FIG. 6 is a diagram showing the structure of a third embodiment of the spectrum spreading receiving apparatus of the present invention;

FIG. 7 is a diagram showing the structure of an automatic frequency control circuit of the third embodiment;

FIG. 8 is a diagram showing the structure of an automatic frequency control circuit of a fourth embodiment;

FIG. 9 is a diagram showing the structure of a conventional receiving apparatus; and

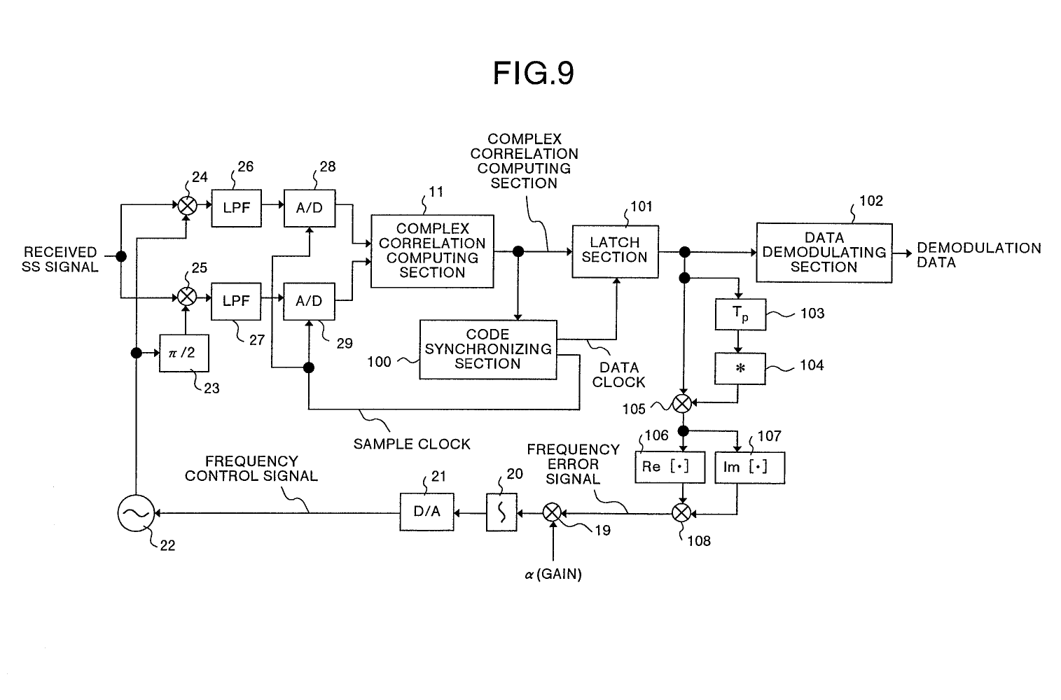

FIG. 10 is a diagram showing frequency error signal eₙ normalized with L⁴ with respect to frequency offset Δω.

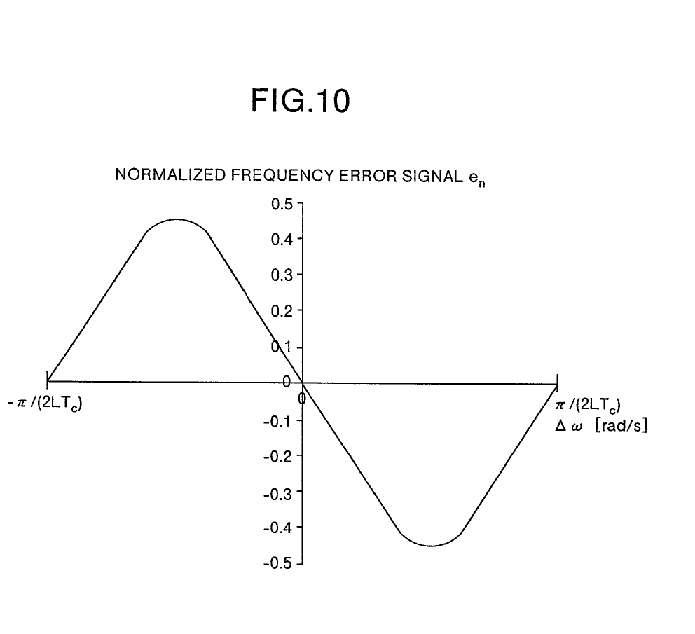

### DESCRIPTION OF THE PREFERRED EMBODIMENTS

Embodiments of the automatic frequency control apparatus and the spectrum spread receiving apparatus using the automatic frequency control apparatus according to the present invention will be described in detail with reference to the accompanying drawings. This invention is not restricted to the embodiments described below.

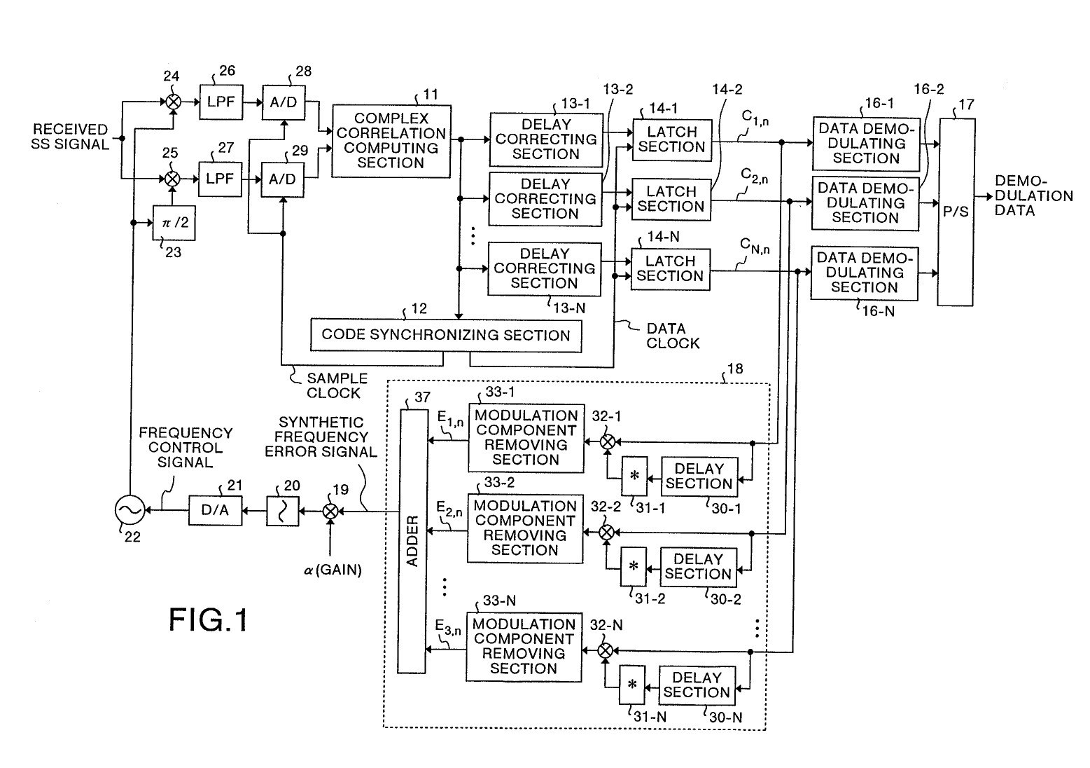

FIG. 1 is a diagram showing the structure of the spectrum spread receiving apparatus of the present invention. In this figure, reference numeral 11 denotes a complex correlation computing section 11, reference numeral 12 denotes a code synchronizing section 12, reference numerals 13-1, 13-2, . . . , 13-N denote delay correcting sections, reference numerals 14-1, 14-2, . . . , 14-N denote latch sections, reference numerals 16-1, 16-2, . . . , 16-N denote data demodulating sections, reference numeral 17 denotes a parallel/serial converting section (P/S), reference numeral 18 denotes a synthetic frequency error signal generating section, reference numeral 19 denotes a multiplier, reference numeral 20 denotes an integrator, reference numeral 21 denotes a D/A converting section, reference numeral 22 denotes a voltage control oscillating portion (VCO), reference numeral 23 denotes a phase shifting section, reference numerals 24, 25 denote multiplying sections, reference numerals 26, 27 denote low-pass filters, and reference numerals 28, 29 denote an A/D converting section. Like reference numerals are attached to the same structure as the conventional art and a description thereof is omitted. In this embodiment, an automatic frequency control apparatus which carries out local carrier frequency synchronization at a high precision using inverse spreading signals of all channels output from a single complex correlator and a spectrum spreading receiving apparatus using the same automatic frequency control circuit are obtained.

In the synthetic frequency error signal generating section 18, reference numerals 30-1, 30-2, . . . , 30-N denote delay sections, reference numerals 31-1, 31-2, . . . , 31-N denote complex conjugate computing sections, reference numerals 32-1, 32-2, . . . , 32-N denote multipliers, reference numerals 33-1, 33-2, . . . , 33-N denote modulation component removing sections, and reference numeral 37 denotes an adder.

Operation of the transmission side will be explained before proceeding to an explanation of operation of the aforementioned spectrum spread receiving apparatus. The transmission side generates a transmission SS signal by carrying out spectrum spread on the parallel information signal using the same spread code and then providing the spectrum spread codes with different delay times so as to multiplex them. How the transmission SS signal is generated will be described now.

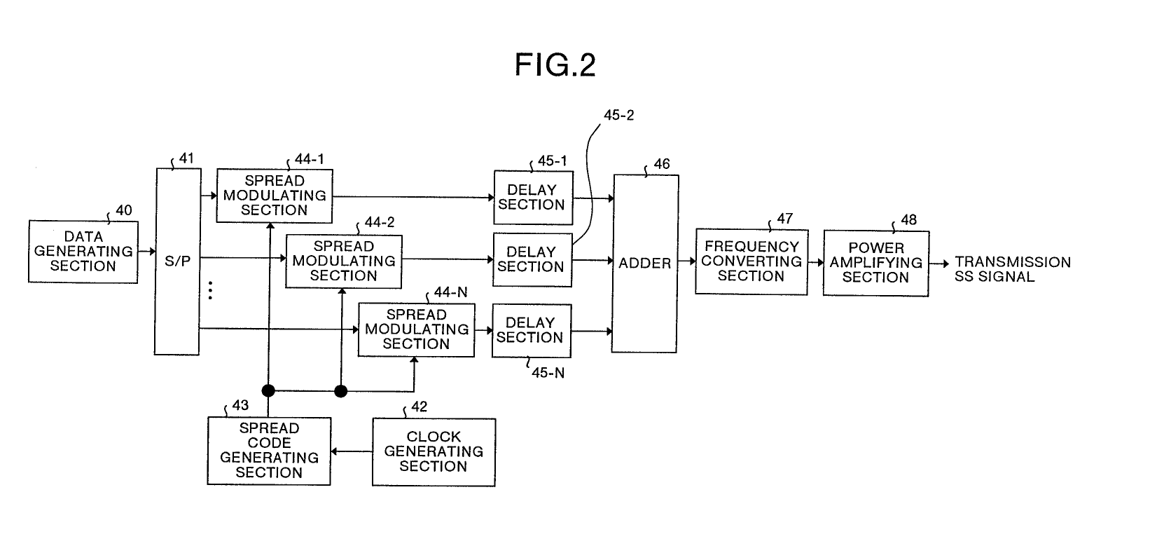

FIG. 2 is a diagram showing the structure of the transmission side. In this figure, reference numeral 40 denotes a data generating section, reference numeral 41 denotes a serial/parallel converting section (S/P), reference numeral 42 denotes a clock generating section, reference numeral 43 denotes a spread code generating section, reference numerals 44-1, 44-2, . . . , 44-N denote spread modulating sections, reference numerals 45-1, 45-2, . . . , 45-N denote delay sections, reference numeral 46 denotes an adder, reference numeral 47 denotes a frequency converting section and reference numeral 48 denotes a power amplifying section.

On the transmission side unit, first, the data generating section 40 generates a digital information signal having a value of “1” or “−1”. Digital information signal generation velocity is referred to as bit rate and digital information signal bit rate is written as R_{b}.

The S/P 41 converts the aforementioned digital information signal to parallel information signals of N channels (N is a natural number 2 or more). The multiplexing number N is a value less than spread code length L [bit] The generation velocity of the parallel information signal of each channel is referred to as parallel bit rate and the parallel bit rate is written as Rₚ (=Rₚ/N)

Each spread modulating section generates N-channel parallel spectrum spread signal by multiplying each of the N-channel parallel information signal with the spread code generated by the spread code generating section 43. The parallel spectrum spread signal has a chip rate R_{c}. The spread code is a spread code having a value of “1” or “−1” and code length L and a clock frequency band of Rₚ×L created by the clock generating section 42. This spread code has an easy code creating circuit structure and further a sharp auto correlation. For example, M series, Gold code or the like is used. Further, a clock rate created by the clock generating section 42 is referred to as chip rate R_{c} (=L R_{c}) and the clock frequency having the chip rate R_{c} is referred to as chip period T_{c} (=1/R_{c}).

Each delay section provides each of the N-channel spectrum spread signals with different delay times (τ₁T_{c}, τ₂T_{c}, τ₃T_{c}, . . . , τ_{N}T_{c}). The delay coefficients (τ₁, τ₂, τ₃, . . . , τ_{N}) should satisfy a relation of 0<τ₁<τ₂<τ₃<. . . <τ_{N}<L.

The adder 46 generates multiplexed spectrum spread signal by adding all signals output from respective delay sections. Further, the frequency converting section 47 converts the frequency by multiplying the multiplexed spectrum spread signal which is an output of the adder 46 with carrier and finally, the power amplifying section 48 generates transmission SS signal which is a transmission signal, by amplifying the multiplexed spectrum spread signal after frequency conversion.

System constructed with the transmission system and the above described spectrum spread receiving apparatus is referred to as timing offset multiplexing SS system.

Operations of the automatic frequency control apparatus which synchronizes the local carrier in terms of frequency for the received transmission SS signal and the spectrum spread receiving apparatus using the same automatic frequency control apparatus will be described. The automatic frequency control apparatus corresponds to a portion comprised of the complex correlation computing section 11, a code synchronizing section 12, delay correcting sections 13-1, 13-2, . . . , 13-N, latch sections 14-1, 14-2, . . . , 14-N, a synthetic frequency error signal generating section 18, a multiplier 19, an integrator 20, a D/A converter 21, a VCO 22, a phase shift section 23, multipliers 24, 25, LPFs 26, 27, and A/D converters 28, 29.

The spectrum spread receiving apparatus having the structure shown in FIG. 1 carries out quasi-synchronous detection upon received SS signal in the same procedures as the conventional art so as to generate a complex spectrum spread signal. Then, the complex correlation computing section 11 computes the correlation between the complex spectrum spread signal and a spread code generated by the spread code generating section 43 on the transmission side so as to compute a complex correlation signal. Although each of the N-channel parallel spectrum spread signals is obtained by spectrum-spreading the parallel information signal with the same spread code, the correlation between each parallel spectrum spread signal and the parallel spectrum spread signals of remaining channels (N−1) becomes smaller when a correlation peak of each parallel information signal is generated, because the spectrum spread signal is multiplexed in a condition that each delay section on the transmission side is provided with a different delay time. Consequently, the receiving side can demodulate all parallel information signals.

Each delay correcting section provides with a delay correction time of {Tₚ−τ₁T_{c}, Tₚ−τ₂T_{c}, Tₚ−τ₃T_{c}, . . . , Tₚ−τ_{N}T_{c}} so as to correct the delay so that generating timings of correlation peaks of the complex correlation signals to corresponding parallel information signals match each other. Meanwhile, Tₚ is spread code period, which is expressed as Tₚ=1/Rₚ. The timings of the parallel spectrum spread signals out of appropriate timing are matched by adding a delay of each delay section on the transmission side.

The code synchronizing section 12 generates a data clock synchronous with peak generation timings of the N-channel complex correlation signals matched by each delay correcting section, based on a received complex correlation signal. Each latch section latches a peak value of each of the N-channel correlation signals using data clock generated by the code synchronizing section 12.

The synthetic frequency error signal generating section 18 outputs a synthetic frequency error signal corresponding to a frequency offset Δω using all complex correlation peak signals output from each latch section. In the same procedure as the conventional art, the multiplier 19 and the integrator 20 raise S/N ratio of the synthetic frequency error signal and after that, the D/A converting section 21 carries out D/A conversion upon appropriate frequency error signal. The VCO 22 removes frequency offset using a frequency control signal generated by D/A conversion so as to realize frequency synchronism of the local carrier.

On the other hand, each data demodulating section carries out data demodulation processing upon a complex correlation peak signal output from each latch section so as to obtain parallel demodulation data. Then, the P/S 17 generates demodulation data having bit rate R_{b} (=NRₚ) based on parallel demodulation data having N-channel parallel bit rate Rₚ.

With such operation, data demodulation upon a reception signal subjected to timing offset multiplexing is enabled in the spectrum spread receiving apparatus of this embodiment.

Operation of the aforementioned synthetic frequency error signal generating section 18 will be described in detail now. The synthetic frequency error signal generating section 18 obtains a frequency error signal to each channel in the same procedure as the conventional art, using the delay section 30-k (k=1, 2, 3, . . . , N), the complex conjugate computing section 31-k, the multiplier 32-k, and the modulation component removing section 33-k for removing the modulation component corresponding to primary modulation.

The adder 37 adds the frequency error signal corresponding to all channels and computes a synthetic frequency error signal whose S/N ratio is improved. In a subsequent circuit, frequency synchronism of the local carrier using the synthetic frequency error signal having the high S/N ratio is enabled.

The frequency synchronous processing of the local carrier, which is executed in the spectrum spread receiving apparatus of this embodiment, will be described. It is assumed that the primary modulation is BPSK, the length of spread code used for spectrum spread is L bit, chip period is T_{c}, and a value of m (m=1, . . . , L) spread code is uₘ∈{−1, 1}. Further, it is assumed that symbol period of data is Tₚ=LT_{c}, transmission data of k channel at time nTₚ (n is an integer) is a_{k, n}∈{−1, 1}. and angular frequency of transmission carrier is ω_{c}.

First, the spectrum spread receiving apparatus of this embodiment receives the received SS signal expressed by the following equation (5) at time nTₚ+mT_{c}.

$${\sum }_{k = 1}^{N} {a}_{k , n} {u}_{m - {τ}_{k}} COS [ {ω}_{c} ( {nT}_{p} + {mT}_{c} ) ] \qquad ( 5 )$$

If it is assumed that the angular frequency of the local carrier used for quasi-synchronous detection is ω_{c}+Δω, its initial phase is φ and the sampling frequency of the A/D converting section is equal to chip period while there is no quantization error, complex spectrum spread signal R_{nL+m} at time nTₚ+mTₚ=(nL+m) T_{c} can be obtained from the following equation (6).

$${R}_{nL + m} = ( {\sum }_{k = 1}^{N} {a}_{k , n} {u}_{m - {τ}_{k}} ) exp [ - j \{ Δω ( nL + m ) {T}_{c} + φ \} ] \qquad ( 6 )$$

The complex correlation computing section 11 computes the correlation between the aforementioned complex spectrum spread signal and the spread code so as to generate a complex correlation signal. In the timing offset multiplexing SS system, code synchronism to k-channel parallel information signal is established at time nTₚ+(m+τₖ)T_{c}. Then, if complex correlation peak signal corresponding to transmission data a_{k, n} of k channel upon code synchronism is C_{k, n}, C_{k, n} can be obtained from the following equation (7).

$$\begin{matrix}{C}_{k , n} = \frac{1}{L} {\sum }_{m = 1}^{L} {u}_{m} {r}_{nL + m + {τ}_{k}} \\ = {a}_{k , n} \frac{sin [ \frac{Δ ω L {T}_{c}}{2} ]}{sin [ \frac{Δ ω {T}_{c}}{2} ]} exp [ - jΔω \{ ( 2 n + 1 ) L + 1 \} {T}_{c} + \frac{2 φ}{2} ]\end{matrix} \qquad ( 7 )$$

In the above equation (7), the autocorrelation value of a spread code uₘ is always kept 0 except when the codes are synchronous in order to simplify that equation.

Each of the multipliers (32-1 to 32-N) computes a multiplication value Z_{k, n} between the complex correlation peak signal C_{k, n} and the complex conjugation C_{k, n-1} of a complex correlation peak signal before by a symbol. This multiplication value Z_{k, n} can be obtained from the following equation (8).

$$\begin{matrix}{Z}_{k , n} = {C}_{k , n} {C}_{k , n - {1}^{*}} \\ = {a}_{k , n} {a}_{k , n - 1} \frac{{[ \frac{sin ( Δ ω L {T}_{c} )}{2} ]}^{2}}{{[ \frac{sin ( Δ ω {T}_{c} )}{2} ]}^{2}} exp [ - j Δ ωL {T}_{c} ]\end{matrix} \qquad ( 8 )$$

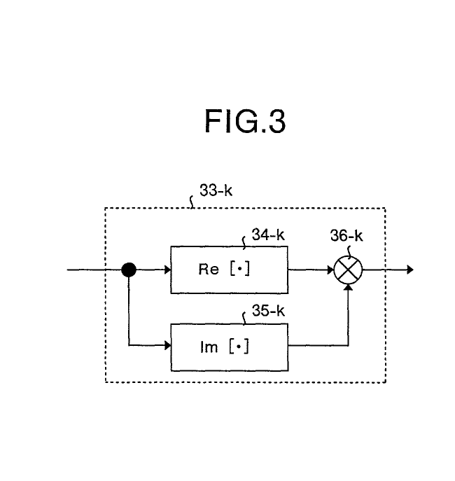

FIG. 3 is a diagram showing the structure of the aforementioned modulation component removing section 33-k. Reference numeral 34-k denotes a real number separating section, reference numeral 35-k denotes an imaginary number separating section, and reference numeral 36-k denotes a multiplier. The modulation component removing section 33-k multiplies a real number portion of Z_{k, n} output from the real number separating section 34-k with an imaginary number portion of Z_{k, n} output from the imaginary number separating section 35-k and outputs a frequency error signal E_{k, n} from which the modulation component a_{k, n} and the modulation component a_{k, n} are removed. The frequency error signal E_{k, n} can be obtained from the following equation (9).

$$\begin{matrix}{E}_{k , n} = Re [ {Z}_{k , n} ] \times Im [ {Z}_{k , n} ] \\ = \frac{{[ \frac{sin ( Δ ω L {T}_{c} )}{2} ]}^{4}}{{[ \frac{sin ( Δ ω {T}_{c} )}{2} ]}^{4}} \times \frac{sin ( - 2 Δω L {T}_{c} )}{2}\end{matrix} \qquad ( 9 )$$

Because a frequency error signal E_{k, n} obtained from the equation (9) and a frequency error signal eₙ obtained from the equation (3) have the same values, it comes that the E_{k, n} has a value corresponding to the frequency offset Δω.

When the adder 37 adds all frequency error signals obtained by the modulation component removing section 33-1 to 33-N, a synthetic frequency error signal GEₙ whose S/N ratio has been improved as compared to the conventional art.

$${GE}_{n} = {\sum }_{k = 1}^{N} {E}_{k , n} \qquad ( 10 )$$

In the same procedure as the conventional art, the multiplier 19 and the integrator 20 raise the S/N ratio of the synthetic frequency error signal and after that, the D/A converter 21 converts an appropriate frequency error signal from digital to analog. After that, the VCO 22 converting section 21 removes the frequency offset using the frequency control signal generated by the D/A conversion in order to achieve the frequency synchronism on the local carrier.

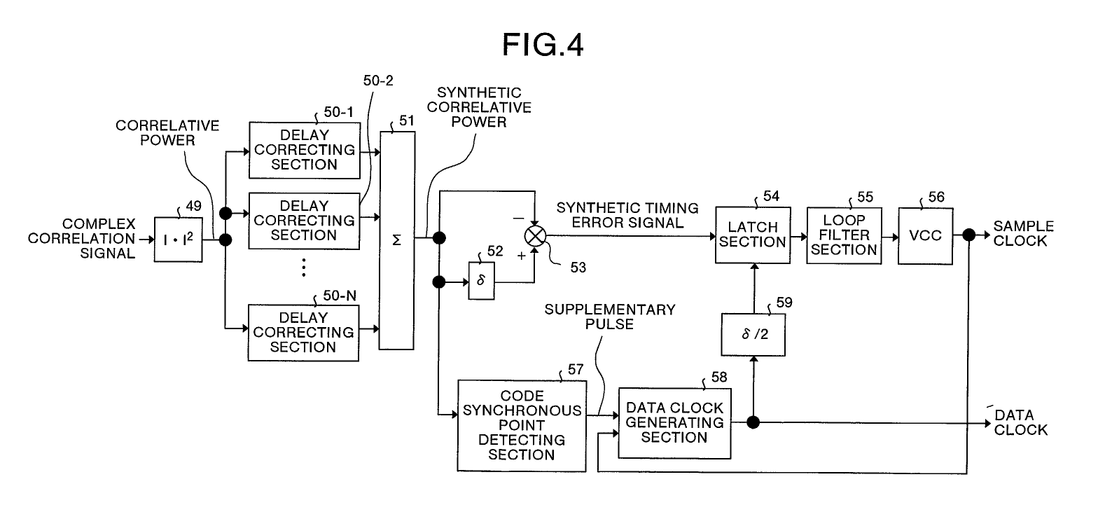

FIG. 4 is a diagram showing the structure of the aforementioned code synchronizing section 12. Reference numeral 49 denotes a correlative power computing section, reference numerals 50-1, 50-2, . . . , 50-N denote a delay correcting section, reference numeral 51 denotes an adder, reference numeral 52 denotes a delay section for delaying a received signal by time δ (0<δ<2T_{c}), reference numeral 53 denotes a subtractor, reference numeral 54 denotes a latch section, reference numeral 55 denotes a loop filter section, reference numeral 56 denotes a voltage control oscillator (VCC), reference numeral 57 denotes a code synchronous point detecting section, reference numeral 58 denotes a data clock generating section, and reference numeral 59 denotes a delay section for delaying a received signal by time δ/2.

In the aforementioned code synchronizing section 12, the correlative power computing section 49 computes a correlative power, which is a square of an absolute value of a complex correlation signal. Each delay correcting section, which receives correlative power values divided to N, provides each correlative power with a delay correction time of {T_{p -τ}₁T_{c}, Tₚ−τ₂T_{c}, Tₚ−τ₃T_{c}, . . . , Tₚ−τ_{N}T_{c}} and matches the peak timings of the correlative power corresponding to each of the N-channel parallel information signals.

The adder 51 adds N correlative powers output from respective delay correcting sections and outputs its addition result as a synthetic correlative power value. Further, the subtractor 53 generates a synthetic timing error signal, which expresses advance/delay of timing phase of a sample clock by subtracting a current synthetic correlative power from a synthetic correlative power delayed by time δ by the delay section 52.

On the other hand, the code synchronous point detecting section 57 detects a reference code synchronous point, in which the synthetic correlative power reaches the maximum peak within spread code period Tₚ and outputs a capture pulse synchronous with that timing. Then, the data clock generating section 58 divides the sample clock based on the capture pulse synchronous with the spread code period so as to generate data clock in which the synthetic correlative power has a rise-up edge at timing of its peak and has the period Tₚ.

The latch section 54 latches the synthetic error signal with the rise-up edge of the data clock delayed by only δ/2 by the delay section 59. Further, the loop filter section 55 removes noise component by filtering the latched synthetic error signal so as to generate a synthetic timing error signal having a high S/N ratio. The VCC 56 changes the timing phase of a clock having a frequency band M times the chip rate R_{c} based on the synthetic timing error signal output from the loop filter section 55 so as to generate a sample clock.

With such operation, the code synchronizing section 12 can realize both data clock code synchronism and sample clock chip timing synchronism.

As described above, according to the first embodiment, the synthetic frequency error signal GEₙ whose S/N ratio is improved as compared to the conventional art is computed based on the frequency error signal E_{k, n} obtained from each peak value of the complex correlation signal (reverse spread signal of all channels output from a single complex correlator) so as to carry out frequency synchronism of the local carrier using this GEₙ. Consequently, as compared to the conventional art, which carries out frequency synchronism using a peak value of a one-channel (dedicated channel) complex correlation signal, a higher precision frequency synchronism can be carried out in a substantially the same circuit scale.

Because the the multiplier 19 and the integrator 20 average the synthetic frequency error signal GEₙ having the high S/N ratio, even if data quantity for use in averaging processing is reduced, the high precision frequency synchronism can be carried out. That is, as compared to the conventional art, which carries out the frequency synchronism using a peak value of a one-channel complex correlation signal, time necessary for the frequency synchronism can be reduced.

Because the high precision frequency synchronism is enabled, as compared to the conventional art in which the frequency synchronism is carried out using a peak value of the one-channel complex correlation signal, more excellent data demodulation characteristic can be assured.

Although it is mentioned above that the binary digital signal having the value of “1” or “−1” can be handled, this embodiment is not restricted to this example, but other binary data maybe used. Further, it is permissible to output the demodulation data corresponding to each channel directly without using the P/S 17. The delay amount to be provided the delay sections 30-1 to 30-N with may be qTₚ (q is a natural number). Although a case where the BPSK is applied as the primary modulation has been described, the present invention is not restricted to this example, but the present invention can correspond to other modulation method than the BPSK by using the modulation component removing section corresponding to the primary modulation.

A second embodiment of this invention will now be explained. In the second embodiment, a timing offset multiplexing SS system is presumed like the first embodiment, so that an automatic frequency control circuit, which carries out high precision local carrier frequency synchronization and a spectrum spread receiving apparatus using the automatic frequency control circuit are obtained using reverse spread signals of all channels output from a single complex correlator. Further, according to this embodiment, the synthetic frequency error signal is obtained from the complex correlation peak signal corresponding to each parallel information signal without using the delay sections (30-1 to 30-N) by using the fact that each parallel spectrum spread signal is provided with a different time offset. Consequently, frequency synchronization of the local carrier is carried out with a smaller circuit scale than the first embodiment.

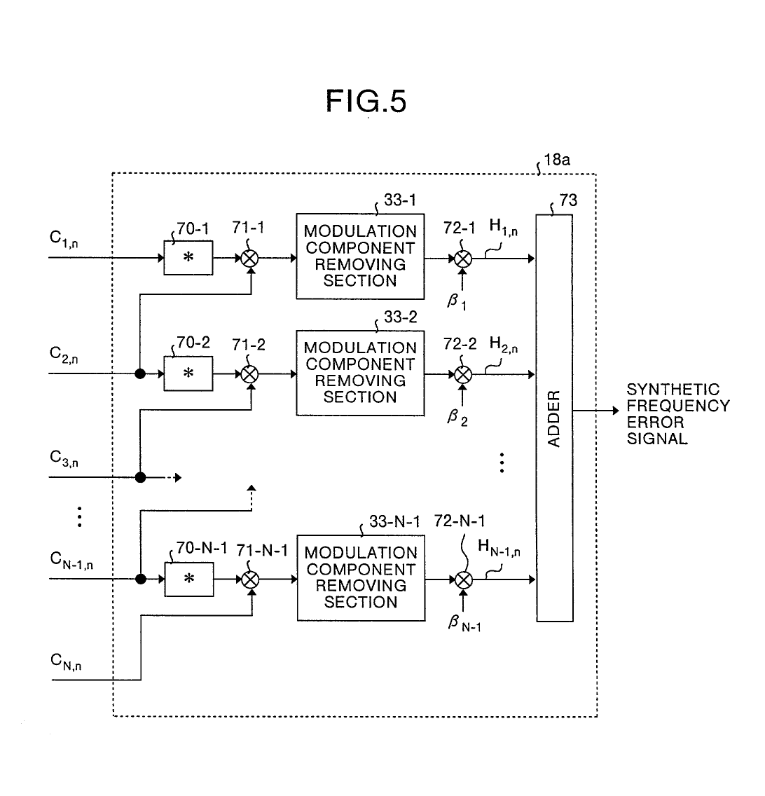

FIG. 5 is a diagram showing the structure of the synthetic frequency error signal generating section 18a of the second embodiment. In this figure, like reference numerals are attached to the same components as the spectrum spread receiving apparatus of the first embodiment and a description thereof is omitted. Thus, the synthetic frequency error signal generating section 18 shown in FIG. 1 is replaced with a synthetic frequency error signal generating section 18a shown in FIG. 5.

Referring to FIG. 5, reference numerals 70-1, 70-2, . . . , 70-N denote complex conjugation computing sections, and reference numerals 71-1, 71-2, . . . , 71-N and 72-1, 72-2, . . . , 72-N denote multipliers, and reference numeral 73 denotes an adder.

This synthetic frequency error signal generating section 18a operates as follows. The synthetic frequency error signal generating section 18a computes a frequency error signal corresponding to a frequency offset originated from a difference in delay time between the aforementioned delay section 45-k on the transmission side and the delay unit 45-k +1 using the complex conjugation computing section 70-k (k=1, 2, 3, . . . , N−1), the multiplying section 71-k, the modulation component removing section 33-k for removing the modulation component corresponding to the primary modulation.

The adder 73 computes a synthetic frequency error signal whose S/N ratio is improved as compared to the conventional art by adding all frequency error signals between respective channels. Consequently, in subsequent circuits, the frequency synchronization of the local carrier using the synthetic frequency error signal having such a high S/N ratio is enabled.

The frequency synchronization processing of the local carrier using the synthetic frequency error signal generating section 18a of this embodiment will be described. Like the first embodiment, it is assumed in the second embodiment that the primary modulation is BPSK, the length of spread code used for spectrum spread is L bit, chip period is T_{c}, transmission data of k channel at time nTₚ (n is an integer) is a_{k, n}∈{−1, 1} and the angular frequency offset is Δω. Therefore, a complex correlation peak signal C_{k, n} corresponding to transmission data a_{k, n} of k channel when code is synchronous can be obtained from the equation (7).

The multiplier 71-k computes a multiplication value P_{k, n} between the complex correlation peak signal C_{k+1, n} and complex conjugation C_{k, n} of the complex correlation peak signal provided with a different delay time from C_{k+1, n}. This multiplication value P_{k, n} can be obtained from the following equation (11).

$$\begin{matrix}{P}_{k , n} = {C}_{k + 1 , n} {C}_{k , n} \\ = {a}_{k + 1 , n} {a}_{k , n} \frac{{[ \frac{sin ( Δ ω L {T}_{c} )}{2} ]}^{2}}{{[ \frac{sin ( Δ ω {T}_{c} )}{2} ]}^{2}} exp [ - j Δ ω ( {t}_{k + 1} - {t}_{k} ) {T}_{c} ]\end{matrix} \qquad ( 11 )$$

In the modulation component removing section 33-k, a real number part and an imaginary number part of P_{k, n} output from the real number separating section 34-k are multiplied with each other like the first embodiment, so that a signal from which the modulation component a_{k+1,n} and the modulation component a_{k, n} are removed, is output. Further, in the multiplying section 72-k, a frequency error signal H_{k,n} is output by multiplying a signal output from the modulation component removing section 33-k with a weighting coefficient βₖ. The frequency error signal H_{k,n} can be obtained from the following equation (12).

$$\begin{matrix}{H}_{k , n} = {β}_{k} \times R e [ {P}_{k , n} ] \times I m [ {P}_{k , n} ] & \\ = {β}_{k} \times \frac{{[ sin Δω L \frac{{T}_{c}}{2} ]}^{4}}{{[ sin Δω \frac{{T}_{c}}{2} ]}^{4}} \times \frac{sin \{ - 2 Δω ( {t}_{k + 1} - {t}_{k} ) {T}_{c} \}}{2} & ( 12 )\end{matrix}$$

The weighting coefficient βₖ is an arbitrary value which is larger than 0. Further, the frequency error signal H_{k,n} obtained from the equation (12) has a value corresponding to the frequency offset Δω.

The adder 73 computes the synthetic frequency error signal GHₙ, whose S/N ratio is improved as compared to the conventional art by adding all the frequency error signals H_{k, n} as shown in the equation (13).

$${GH}_{n} = {\sum }_{k = 1}^{N - 1} {H}_{k , n} \qquad ( 13 )$$

The frequency control is carried out using the synthetic frequency error signal GHₙ like the first embodiment so as to achieve frequency synchronization of the local carrier.

According to the second embodiment, the same effect as the first embodiment can be secured and the synthetic frequency error signal can be obtained from the complex correlation peak signal corresponding to each parallel information signal without using the delay sections (30-1 to 30-N) by using the fact that the respective parallel spectrum spread signals are provided with different time offsets. Consequently, the frequency synchronization of local carrier can be carried out in a smaller circuit scale than the first embodiment.

A third embodiment will be described now. According to the third embodiment, a timing offset multiplexing SS system is presumed, so that an automatic frequency control apparatus, which estimates a frequency offset amount at a high precision using reverse spread signals of all channels output from a single complex correlator and carries out data demodulation using reverse spread signal whose phase shift amount is corrected corresponding to that estimated frequency offset amount, and a spectrum spread receiving apparatus employing that automatic frequency control apparatus are obtained.

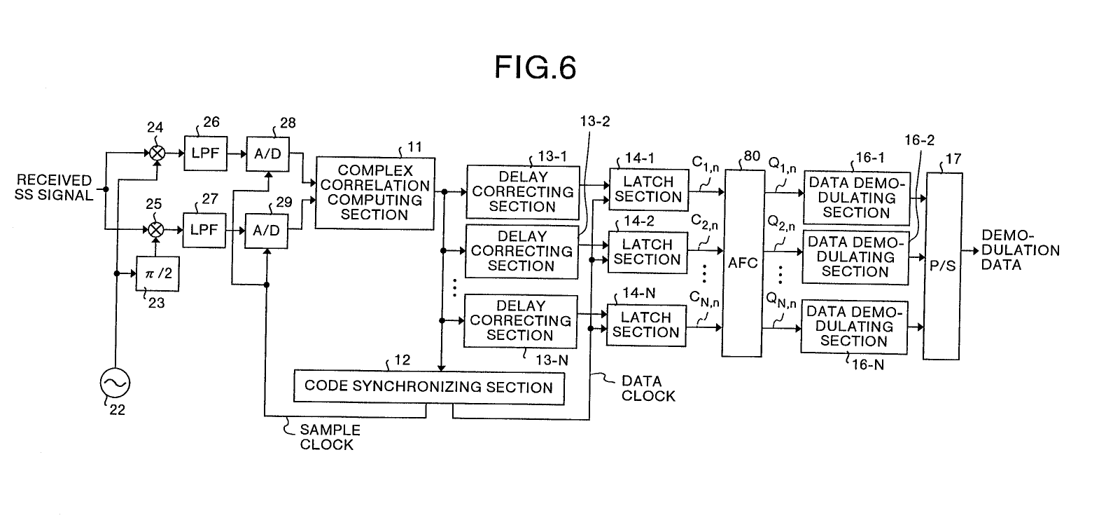

FIG. 6 is a diagram showing the structure of the spectrum spread receiving apparatus of the second embodiment. In this figure, like reference numerals are attached to the same components as the spectrum spread receiving apparatus of the first embodiment and a description thereof is omitted. More specifically, in order to carry out frequency synchronization of the local carrier, an automatic frequency control circuit 80 shown in FIG. 6 is employed instead of the synthetic frequency error signal generating section 18, the multiplier 19, the integrator 20 and the D/A converting section 21.

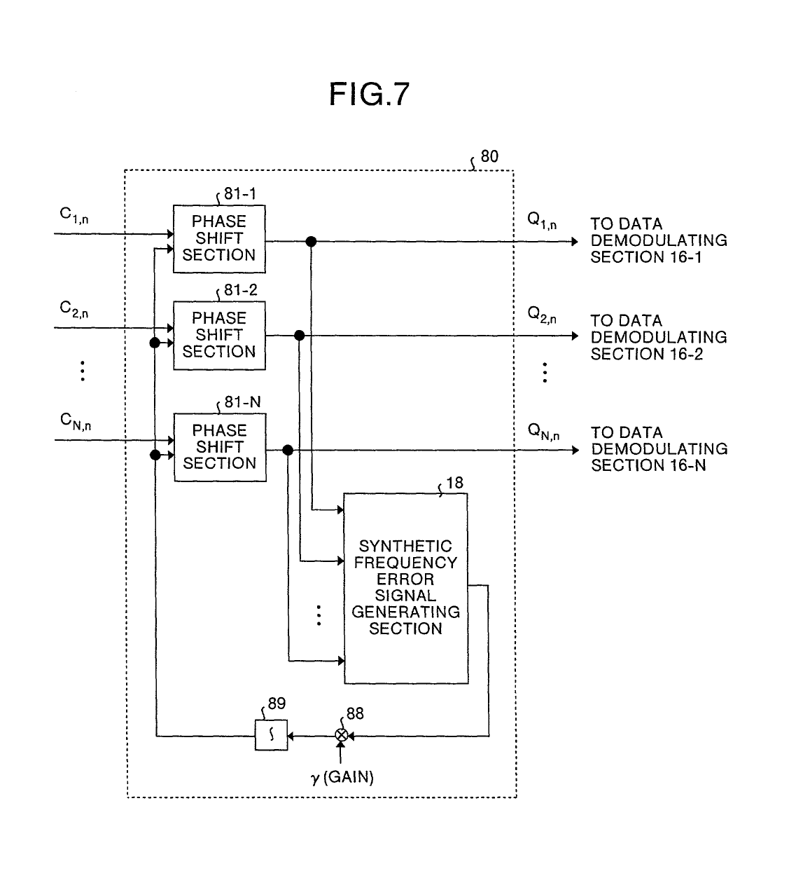

FIG. 7 is a diagram showing the structure of the aforementioned automatic frequency control circuit 80. In this figure, reference numerals 81-1, 81-2, . . . , 81-N denote phase shift sections, reference numeral 18 denotes the synthetic frequency error signal generating section used in the first embodiment, reference numeral 88 denotes a multiplier and reference numeral 89 denotes an integrator.

The automatic frequency control circuit 80 operates as follows. In the automatic frequency control circuit 80, the phase shift section 81-k (k=1, 2, . . . , N) shifts the complex correlation peak signal C_{k, n} indicated with the aforementioned equation (7) by a phase shift amount Δω′ { (2n +1)L+2τₖ+1}Tc/2[rad] so as to remove a frequency offset multiplied with the C_{k, n}. The Δω′0 is an estimated angular frequency offset obtained by the following signal processing. Further, the “shifting the phase” means a processing based on the equations (14) and (15) where the same phase (real number) component of a certain parallel spectrum spread signal is Iₛ, the orthogonal (imaginary number) component is Qₛ, and a certain phase shift amount is γ[rad].

Id=\sqrt{Iₛ²+Qₛ²}×cos (φ+γ) (14)

Qd=\sqrt{Iₛ²+Qₛ²}×sin (φ+γ) (15)

I_{d} and Q_{d} indicate the same phase (real number) component and orthogonal (imaginary number) component of a parallel spectrum spread signal after the phase shift. φ[rad] is calculated according to the equation (16).

$$φ = {tan}^{- 1} ( \frac{{Q}_{s}}{{I}_{s}} ) \qquad ( 16 )$$

A synthetic frequency error signal corresponding to a differential value between the angular frequency offset Δω and the estimated angular frequency offset Δω′ is obtained using the synthetic frequency error signal generating section 18 like the first embodiment. Further, the S/N ratio of the synthetic frequency error signal is raised using the multiplier 88 and the integrator 89 and then, the frequency synchronization of local carrier is carried out using this synthetic frequency error signal having such a raised S/N ratio.

Next, frequency synchronization processing for the local carrier using the automatic frequency control circuit 80 of the third embodiment will be described. Like the first embodiment, it is assumed in the third embodiment that the primary modulation is BPSK, the length of spread code used for spectrum spread is L bit, chip period is T_{c}, and transmission data of k channel at time nTₚ (n is an integer) is a_{k,n}∈{−1, 1}. Consequently, a complex correlation peak signal C_{k, n} corresponding to transmission data a_{k, n} of k channel when code is synchronous can be obtained from the following equation (7).

$${Q}_{k , n} = {a}_{k , n} \frac{sin [ \frac{Δω L {T}_{c}}{2} ]}{sin [ \frac{Δω {T}_{c}}{2} ]} exp [ - j ( Δω - {Δω}^{′} ) \{ ( 2 n + 1 ) L + 2 {τ}_{k} + 1 \} {T}_{c} + \frac{2 φ}{2} ] \qquad ( 17 )$$

The phase shift section 81-k outputs a signal Q_{k,n} in which the complex correlation peak signal C_{k,n} is shifted by only a phase shift amount Δω′ {(2n+1)L+2τₖ+1}T_{c}/2[rad].

The synthetic frequency error signal generating section 18 outputs a synthetic frequency error signal GIₙ by inputting Q_{l,n} to Q_{N,n} obtained from the equation (17) instead of C_{l,n} to C_{N,n} in the first embodiment. The synthetic frequency error signal GIₙ can be obtained from the following equation (18).

$$G {I}_{n} = N \times \frac{{[ sin Δω L \frac{{T}_{c}}{2} ]}^{4}}{{[ sin Δω \frac{{T}_{c}}{2} ]}^{4}} \times \frac{sin \{ - 2 ( Δω - {Δω}^{′} ) \} {LT}_{c}}{2} ] \qquad ( 18 )$$

Because the synthetic frequency error signal GIₙ has a value corresponding to Δω-Δω′, the frequency synchronization of the local carrier can be achieved by updating the estimated angular frequency offset Δω′ so that GIₙ turns to 0.

According to the third embodiment, the automatic frequency control circuit 80 estimates a frequency offset of local carrier and further, the phase shift sections 81-1 to 81-N remove a frequency offset applied to each complex correlation peak signal. Consequently, as compared to the conventional art, which carries out frequency synchronization using a peak value of the complex correlation signal of a single channel like the first embodiment, the frequency synchronization at a higher precision can be achieved in substantially the same circuit scale.

A fourth embodiment of will now be explained. According to the fourth embodiment, a timing offset multiplexing SS system is presumed like the third embodiment, so that an automatic frequency control apparatus, which estimates a frequency offset amount at a high precision using reverse spread signals of all channels output from a single complex correlator and carries out data demodulation using a reverse spread signal whose phase shift amount is corrected corresponding to that estimated frequency offset amount, and a spectrum spread receiving apparatus employing the same automatic frequency control apparatus are obtained. Further, the synthetic frequency error signal is obtained from the complex correlation peak signal of each parallel information signal without using the delay sections by using the fact that respective parallel spectrum spread signals are provided with different time offsets. Consequently, the frequency synchronization of the local carrier can be achieved in a smaller circuit scale than the third embodiment.

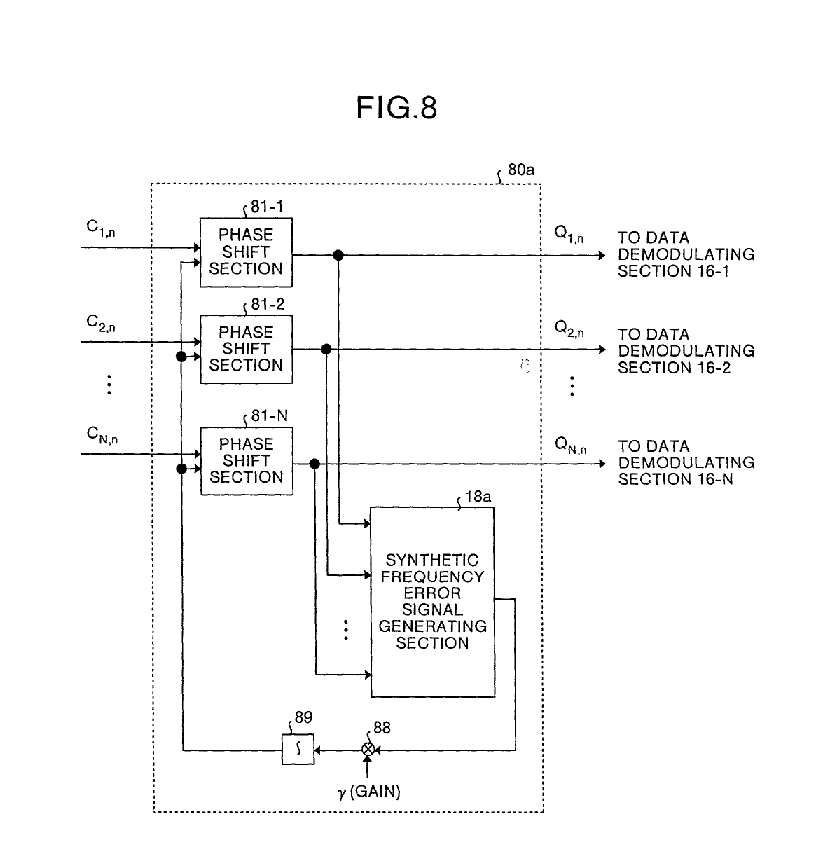

FIG. 8 is a diagram showing the structure of an automatic frequency control circuit 80a of the fourth embodiment. Like reference numerals are attached to the same components as the spectrum spread receiving apparatus of the third embodiment and a description thereof is omitted. More specifically, the automatic frequency control circuit shown in FIG. 6 is replaced with the automatic frequency control circuit 80a shown in FIG. 8.

In FIG. 8, like reference numerals are attached to the same components as the automatic frequency control circuit 80 of the third embodiment and a description thereof is omitted. More specifically, the synthetic frequency error generating section 18 shown in FIG. 7 is replaced with the synthetic frequency error generating section 18a shown in FIG. 8.

The automatic frequency control circuit 80a operates as follows. In the automatic frequency control circuit 80a, the phase shift section 81-k (k=1, 2, . . . , N) shifts the phase of a complex correlation peak signal C_{k, n} expressed with the aforementioned equation (7) by only a phase shift amount Δω″ of {(2n+1)L+2τ^{k}+1}T_{c}/2 [rad] so as to remove a frequency offset multiplied with the C_{k, n}. The Δω″ is an estimated angular frequency offset obtained by the following signal processing.

A synthetic frequency error signal corresponding to a differential value between an angular frequency offset Δω and an estimated angular frequency offset Δω″ is obtained using the synthetic frequency error signal generating section 18a like the second embodiment. Further, the S/N ratio of the synthetic frequency error signal is raised using the multiplier 88 and the integrator 89 and then, the frequency synchronization of the local carrier is achieved using the synthetic frequency error signal having such a raised S/N ratio.

Frequency synchronization processing of the local carrier in case where the automatic frequency control circuit 80a of this embodiment is used will be described. If it is assumed that the primary modulation is BPSK, the length of a spread code for use in spectrum spread is L bits, the chip period is T_{c}, and the value of transmission data of k channel at time nTₚ (n is an integer) is a_{k,n}∈{−1, 1} like the first embodiment, a complex correlation peak signal C_{k, n} corresponding to transmission data a_{k, n} of k channel when code is synchronous can be obtained from the aforementioned equation (7).

The phase shift section 81-k outputs a signal Q_{k, n}, in which the complex correlation peak signal C_{k, n} is shifted in phase by only a phase shift amount of Δω″{(2n+1)L+2τₖ+1}T_{c}/2[rad].

The synthetic frequency error generating section 18a outputs a synthetic frequency error signal GIₙ by inputting each of Q_{l,n} to Q_{N, n} obtained from the following equation (19) instead of C_{l, n} to C_{N,n} of the first embodiment. The synthetic frequency error signal GJₙ can be obtained from the following equation (20).

$${Q}_{k , n} = {a}_{k , n} \frac{sin [ \frac{Δω L {T}_{c}}{2} ]}{sin [ \frac{Δω {T}_{c}}{2} ]} exp [ - j ( Δω - {Δω}^{′} ) \{ ( 2 n + 1 ) L + 2 {t}_{k} + 1 \} {T}_{c} + \frac{2 φ}{2} ] \qquad ( 19 )$$

$${GJ}_{n} = {\sum }_{k = 1}^{N - 1} [ {β}_{k} \times \frac{{( sin Δω L \frac{{T}_{c}}{2} )}^{4}}{{( sin Δω \frac{{T}_{c}}{2} )}^{4}} \times \frac{sin \{ - 2 ( Δω - {Δω}^{″} ) ( {t}_{k + 1} - {t}_{k} ) {T}_{c} \}}{2} \qquad ( 20 )$$

The synthetic frequency error signal GJₙ can realize the frequency synchronization of the local carrier by updating the estimated angular frequency offset Δω″ so that GJₙ becomes 0 in order to obtain a value corresponding to Δω-Δω″.

As described above, according to the fourth embodiment, the same effect as the third embodiment can be obtained. In addition, the synthetic frequency error signal is obtained from the complex correlation peak signal of each parallel information signal without using the delay section, by using the fact that respective parallel spectrum spread signals are provided with different time offset. Consequently, the frequency synchronization of the local carrier can be carried out at a high precision in a smaller circuit scale than the third embodiment.

As described above, according to one aspect of the present invention, the synthetic frequency error signal GEₙ having an improved S/N ratio as compared to the conventional technology is computed based on the frequency error signal E_{k,n} obtained from each of the peak values of the complex correlation signals (reverse spread signals of all channels output from a single complex correlator) corresponding to parallel information signals of N channels and then, the frequencies of the local carriers are synchronized using this GEₙ. Consequently, it is possible to obtain an automatic frequency control apparatus capable of carrying out the frequency synchronization at a much higher precision with substantially the same circuit scale as compared to the conventional technology, in which the frequency synchronization is carried out using a peak value of the complex correlation signal of a single channel (dedicated channel).

Moreover, the synthetic frequency error signal corresponding to the frequency offset is output based on all the complex correlation peak signals output from each latch unit and the S/N ratio of the synthetic frequency error signal is raised with a subsequent circuit. Consequently, it is possible to obtain an automatic frequency control apparatus capable of carrying out the frequency synchronization at a higher precision even if the quantity of data used for averaging processing is reduced.

Furthermore, the synthetic frequency error signal is obtained without using the delay unit (delay sections 30-1 to 30-N) from the complex correlation peak signal corresponding to each parallel information signal by using the fact that respective parallel spectrum spread signals are provided with different time offsets. Consequently, it is possible to obtain an automatic frequency control apparatus capable of carrying out the frequency synchronization of the local carrier with a smaller circuit scale.

According to another aspect of the present invention, the automatic frequency control apparatus estimates a frequency offset in the local carrier and further, removes the frequency offset attached to each complex correlation peak signal. Consequently, it is possible to obtain an automatic frequency control apparatus capable of carrying out the frequency synchronization at a much higher precision with substantially the same circuit scale as compared to the conventional technology, in which the frequency synchronization is carried out using a peak value of the complex correlation signal of a single channel (dedicated channel).

Moreover, the synthetic frequency error signal corresponding to the frequency offset is output based on a complex correlation peak signal after a phase shift and the S/N ratio of that synthetic frequency error signal is raised with a subsequent circuit. Consequently, it is possible to obtain an automatic frequency control apparatus capable of carrying out the frequency synchronization at a higher precision even if the quantity of data used for averaging processing is reduced.

Furthermore, the synthetic frequency error signal is obtained without using the delay section from the complex correlation peak signal of each parallel information signal by using the fact that respective parallel spectrum spread signals are provided with different time offsets. Consequently, it is possible to obtain an automatic frequency control apparatus capable of carrying out the frequency synchronization of the local carrier with a smaller circuit scale.

According to still another aspect of the present invention, the synthetic frequency error signal GEₙ having an improved S/N ratio as compared to the conventional technology is computed based on the frequency error signal E_{k,n} obtained from each of the peak values of the complex correlation signals (reverse spread signals of all channels output from a single complex correlator) corresponding to parallel information signals of N channels and then, the frequencies of the local carriers are synchronized using this GEₙ. Consequently, it is possible to obtain a spectrum spread receiving apparatus capable of carrying out the frequency synchronization at a much higher precision with substantially the same circuit scale as compared to the conventional technology, in which the frequency synchronization is carried out using a peak value of the complex correlation signal of a single channel (dedicated channel).

Moreover, the synthetic frequency error signal corresponding to the frequency offset is output based on all the complex correlation peak signals output from each latch unit and the S/N ratio of the synthetic frequency error signal is raised with a subsequent circuit. Consequently, it is possible to obtain a spectrum spread receiving apparatus capable of carrying out the frequency synchronization at a higher precision even if the quantity of data used for averaging processing is reduced.

Furthermore, the synthetic frequency error signal is obtained without using the delay unit (delay secions 30-1 to 30-N) from the complex correlation peak signal corresponding to each parallel information signal by using the fact that respective parallel spectrum spread signals are provided with different time offsets. Consequently, it is possible to obtain a spectrum spread receiving apparatus capable of carrying out the frequency synchronization of the local carrier with a smaller circuit scale.

According to still another aspect of the present invention, the automatic frequency control apparatus estimates a frequency offset in the local carrier and further, removes the frequency offset attached to each complex correlation peak signal. Consequently, it is possible to obtain a spectrum spread receiving apparatus capable of carrying out the frequency synchronization at a much higher precision with substantially the same circuit scale as compared to the conventional technology, in which the frequency synchronization is carried out using a peak value of the complex correlation signal of a single channel (dedicated channel).

Moreover, the synthetic frequency error signal corresponding to the frequency offset is output based on a complex correlation peak signal after a phase shift and the S/N ratio of that synthetic frequency error signal is raised with a subsequent circuit. Consequently, it is possible to obtain a spectrum spread receiving apparatus capable of carrying out the frequency synchronization at a higher precision even if the quantity of data used for averaging processing is reduced.

Furthermore, the synthetic frequency error signal is obtained without using the delay section from the complex correlation peak signal of each parallel information signal by using the fact that respective parallel spectrum spread signals are provided with different time offsets. Consequently, it is possible to obtain a spectrum spread receiving apparatus unit capable of carrying out the frequency synchronization of the local carrier with a smaller circuit scale.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An automatic frequency control apparatus used in a spectrum spread receiving apparatus and which receives a spectrum spread signal subjected to timing offset multiplexing, said automatic frequency control apparatus comprising:
a quasi-synchronous detecting unit which generates a complex spectrum spread signal by mixing an orthogonal local carrier in the received spectrum spread signal;
a complex correlation computing unit which computes the correlation between the complex spectrum spread signal and a spread code and outputs the result of the computation as a complex correlation signal;
a code synchronizing unit which generates a sample clock for sampling the complex spectrum spread signal and a data clock synchronous with a repetitive period of the spread code based on the complex correlation signal;
a delay correcting unit which divides the complex correlation signal to N signals, where N is the quantity of binary parallel information system on the transmission side, and corrects the delays of the N signals so that peak value occurrence timings of complex correlation signals with respect to each binary parallel information are matched;
a latch unit which latches a peak value of the complex correlation signals with respect to each binary parallel information using the data clock so as to output complex correlation peak signals;
a synthetic frequency error signal generating unit which generates a synthetic frequency error signal based on the complex correlation peak signals; and
a frequency correcting unit which corrects frequency offset of the local carrier based on the synthetic frequency error signals.

2. The automatic frequency control apparatus according to claim 1, wherein said synthetic frequency error signal generating units includes,
a delay unit which delays each of the complex correlation peak signals;
a complex conjugation computing unit which outputs a complex conjugation value corresponding to every complex correlation peak signal after the delay unit has performed the delay;
a multiplying unit which multiplies each of the complex correlation peak signals with each of a complex conjugation value corresponding to that complex correlation peak signal individually so as to output multiplication results;
a modulation component removing unit which carries out processing for removing a modulation component corresponding to primary modulation individually for each of the multiplication results so as to output frequency error signals; and
an adding unit which adds the frequency error signals so as to output a synthetic frequency error signal.

3. The automatic frequency control apparatus according to claim 1, wherein said synthetic frequency error signal generating units includes,
a multiplying unit which multiplies a complex conjugation value corresponding to each of the complex correlation peak signals with a complex correlation peak signal different from the complex correlation peak signal subjected to complex conjugation computation processing so as to output multiplication results;
a modulation component removing unit which carries out processing for removing a modulation component corresponding to primary modulation individually for each of the multiplication results so as to output frequency error signals; and
an adding unit which adds the frequency error signals after weighting processing so as to output a synthetic frequency error signal.

4. An automatic frequency control apparatus used in a spectrum spread receiving apparatus and which receives a spectrum spread signal subjected to timing offset multiplexing, said automatic frequency control apparatus comprising:
a quasi-synchronous detecting unit which generates a complex spectrum spread signal by mixing an orthogonal local carrier in the received spectrum spread signal;
a complex correlation computing unit which computes the correlation between the complex spectrum spread signal and a spread code and outputs the result of the computation as a complex correlation signal;
a code synchronizing unit which generates a sample clock for sampling the complex spectrum spread signal and a data clock synchronous with a repetitive period of the spread code based on the complex correlation signal;
a delay correcting unit which divides the complex correlation signal to N signals, where N is the quantity of binary parallel information system on the transmission side, and corrects the delays of the N signals so that peak value occurrence timings of the complex correlation signals with respect to each binary parallel information are matched;
a latch unit which latches peak values of the complex correlation signals with respect to each of the binary parallel information using the data clock so as to output complex correlation peak signals;
an automatic frequency control apparatus which computes an estimated frequency offset amount based on each of the complex correlation peak signals so as to shift phases of each of the complex correlation peak signals by an amount corresponding to the estimated frequency offset amount.

5. The automatic frequency control apparatus according to claim 4, wherein said automatic frequency control apparatus includes,
a phase shifting unit which shifts phases of each of the complex correlation peak signals by an amount corresponding to the estimated frequency offset amount;
a delay unit which delays each of the complex correlation peak signals after the phase has been shifted by said phase shifting unit;
a complex conjugation computing unit which outputs a complex conjugation value corresponding to each of the complex correlation peak signals after the delay unit has performed the delay;
a multiplying unit which multiplies each of the complex correlation peak signals with a complex conjugation value corresponding to that complex correlation peak signal individually so as to output multiplication results;
a modulation component removing unit which carries out processing for removing a modulation component corresponding to primary modulation individually for each of the multiplication results so as to output frequency error signals;
an adding unit which adds the frequency error signal so as to output synthetic frequency error signals; and
an offset amount estimating unit which estimates a frequency offset amount of local carrier based on each of the synthetic frequency error signals.

6. The automatic frequency control apparatus according to claim 4, wherein said automatic frequency control apparatus includes,
a phase shifting unit which shifts a phase of each of the complex correlation peak signals by an amount corresponding to the estimated frequency offset amount;
a multiplying unit which multiplies a complex conjugation value corresponding to each of the complex correlation peak signals after the phase shifting unit has performed the phase shift with a complex correlation peak signal different from the complex correlation peak signal subjected to complex conjugation computation processing so as to output multiplication results;
a modulation component removing unit which carries out processing for removing a modulation component corresponding to primary modulation individually for each of the multiplication results so as to output frequency error signals;
an adding unit which adds the frequency error signals after weighting processing so as to output synthetic frequency error signals; and
an offset amount estimating unit which estimates a frequency offset amount of local carrier based on each of the synthetic frequency error signals.

7. A spectrum spread receiving apparatus which receives a spectrum spread signal subjected to timing offset multiplexing, said spectrum spread receiving apparatus comprising:
a quasi-synchronous detecting unit which generates a complex spectrum spread signal by mixing an orthogonal local carrier in the received spectrum spread signal;
a complex correlation computing unit which computes the correlation between the complex spectrum spread signal and a spread code so as to output complex correlation signals as computation results;
a code synchronizing unit which generates a sample clock for sampling the complex spectrum spread signal and a data clock synchronous with a repetitive period of the spread code based on the complex correlation signal;
a delay correcting unit which divides the complex correlation signal to N signals, where N is the quantity of binary parallel information system on the transmission side, and corrects the delays thereof so that peak value occurrence timings of complex correlation signals with respect to each binary parallel information are matched;
a latch unit which latches a peak value of the complex correlation signal with respect to each binary parallel information using the data clock so as to output a complex correlation peak signal;
a synthetic frequency error signal generating unit which generates a synthetic frequency error signal based on each of the complex correlation peak signals;
a frequency correcting unit which corrects frequency offset of the local carrier based on each of the synthetic frequency error signals; and
a data demodulating unit which carries out data demodulation processing with respect to each of the complex correlation peak signals so as to generate demodulation data corresponding to binary parallel information series on transmission side.

8. The spectrum spread receiving apparatus according to claim 7, wherein said synthetic frequency error signal generating unit includes,
a delay unit which delays each of the complex correlation peak signal;
a complex conjugation computing unit which outputs a complex conjugation value corresponding to each of complex correlation peak signals after the delay unit has performed the delay;
a multiplying unit which multiplies each of the complex correlation peak signals with a complex conjugation value corresponding to that complex correlation peak signal individually so as to output multiplication results;
a modulation component removing unit which carries out processing for removing a modulation component corresponding to primary modulation individually for each of the multiplication results so as to output frequency error signals; and
an adding unit which adds the frequency error signal so as to output a synthetic frequency error signal.

9. The spectrum spread receiving apparatus according to claim 7, wherein said synthetic frequency error signal generating unit includes,
a multiplying unit which multiplies a complex conjugation value corresponding to each of the complex correlation peak signals with a complex correlation peak signal different from the complex correlation peak signal subjected to complex conjugation computation processing so as to output multiplication results;
a modulation component removing unit which carries out processing for removing a modulation component corresponding to primary modulation individually for each of the multiplication results so as to output frequency error signals; and
an adding unit which adds the frequency error signals after weighting processing so as to output a synthetic frequency error signal.

10. A spectrum spread receiving apparatus which receives a spectrum spread signal subjected to timing offset multiplexing, said spectrum spread receiving apparatus comprising:
a quasi-synchronous detecting unit which generates a complex spectrum spread signal by mixing an orthogonal local carrier in the received spectrum spread signal;
a complex correlation computing unit which computes the correlation between the complex spectrum spread signal and a spread code so as to output complex correlation signals as computation results;
a code synchronizing unit which generates a sample clock for sampling the complex spectrum spread signal and a data clock synchronous with a repetitive period of the spread code based on the complex correlation signal;
a delay correcting unit which divides the complex correlation signal to N signals, where N is the quantity of binary parallel information system on the transmission side, and corrects the delays of the N signals so that peak value occurrence timings of the complex correlation signals with respect to each of the binary parallel information are matched;
a latch unit which latches a peak value of the complex correlation signal with respect to each of the binary parallel information using the data clock so as to output complex correlation peak signals;
an automatic frequency control apparatus which computes an estimated frequency offset amount based on each of the complex correlation peak signals so as to shift phases of each of the complex correlation peak signal by an amount corresponding to the estimated frequency offset amount; and
a data demodulating unit which carries out data demodulation processing upon each complex correlation peak signal after the phase shift so as to generate demodulation data corresponding to binary parallel information series on transmission side.

11. The spectrum spread receiving apparatus according to claim 10, wherein said automatic frequency control apparatus includes,
a phase shifting unit which shifts phases of each of the complex correlation peak signals by an amount corresponding to the estimated frequency offset amount;
a delay unit which delays each of the complex correlation peak signals after the phase shifting unit has performed the phase shifting;
a complex conjugation computing unit which outputs a complex conjugation value corresponding to each of the complex correlation peak signal after the delay unit has performed the delay;
a multiplying unit which multiplies each of the complex correlation peak signals with each complex conjugation value corresponding to that complex correlation peak signal individually so as to output multiplication results;
a modulation component removing unit which carries out processing for removing a modulation component corresponding to primary modulation individually for each of the multiplication results so as to output frequency error signals;
an adding unit which adds the frequency error signals so as to output synthetic frequency error signals; and
an offset amount estimating unit which estimates a frequency offset amount of local carrier based on each of the synthetic frequency error signal.

12. The spectrum spread receiving apparatus according to claim 10, wherein said automatic frequency control apparatus includes,
a phase shifting unit which shifts phases of each of the complex correlation peak signals by an amount corresponding to the estimated frequency offset amount;
a multiplying unit which multiplies a complex conjugation value corresponding to each of the complex correlation peak signals after the phase shift with a complex correlation peak signal different from the complex correlation peak signal subjected to complex conjugation computation processing so as to output multiplication results;
a modulation component removing unit which carries out processing for removing a modulation component corresponding to primary modulation individually for each of the multiplication results so as to output frequency error signals;
an adding unit which adds the frequency error signals after weighting processing so as to output synthetic frequency error signals; and
an offset amount estimating unit which estimates a frequency offset amount of local carrier based on each of the synthetic frequency error signals.
